(19) United States
(12) Patent Application Publication
(10) Pub. No.: US 2017/0364247 A1
(43) Pub. Date: Dec. 21, 2017

(54) DRAWING INTEGRATION INTO E-MAIL SYSTEM

(71) Applicant: Microsoft Technology Licensing, LLC, Redmond, WA (US)

(72) Inventors: Jason Andrew Cook, Renton, WA (US); Lin Zhong, Bellevue, WA (US); Shahil Soni, Seattle, WA (US)

(21) Appl. No.: 15/183,050

(22) Filed: Jun. 15, 2016

(51) Int. Cl. G06F 3/0484; G06F 17/21; G06F 3/0482; H04L 12/58; G06F 17/24

(52) U.S. Cl. CPC G06F 3/04845; H04L 51/10; H04L 51/04; G06F 17/242; G06F 3/0482; G06F 17/211; G06F 3/04847; G06F 3/04842; G06F 17/212

(57) ABSTRACT

An electronic mail (email) system detects initiation of drawing functionality. A drawing file is then generated on a separate, selected device and uploaded to the e-mail system. The drawing file represents a drawing that is integrated into an electronic mail message, in-line with other message content, in the e-mail system.

### BACKGROUND

Computer systems are currently in wide use. Some such computer systems include electronic mail systems. Electronic mail systems allow users to compose, send and receive electronic mail messages and perform other electronic mail system functionality.

Other computing systems include drawing systems. Such systems expose user input mechanisms that allow a user to draw using the user input mechanisms. The systems may allow the users to perform other functionality as well, such as collaboration among different, even remotely located, users.

For instance, on a desktop computer, when a drawing application is launched, it may expose functionality that allows the user to perform drawing operations using a point and click device (such as a mouse). The user may actuate one of the buttons on the mouse and move the mouse in order to draw lines.

Some computing platforms (such as a tablet computer or a smartphone or others) may also have touch sensitive displays. On such platforms (or even on a desktop computer that has a touch sensitive display device), the drawing application exposes functionality that allows the user to draw an image using his or her finger, or a stylus, or another touch device, simply by touching and dragging the device along the touch sensitive display screen.

The discussion above is merely provided for general background information and is not intended to be used as an aid in determining the scope of the claimed subject matter.

### SUMMARY

An electronic mail (email) system detects initiation of drawing functionality. A drawing file is then generated on a separate, selected device and uploaded to the e-mail system. The drawing file represents a drawing that is integrated into an electronic mail message, in-line with other message content, in the e-mail system.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one example of a computing system architecture.

FIG. 2 is a block diagram of one example of drawing integration logic in more detail.

FIGS. 3A and 3B (collectively referred to herein as FIG. 3) is a flow diagram illustrating one example of the operation of the architecture illustrated in FIGS. 1 and 2 in integrating a drawing into an electronic mail message.

FIG. 4 is a flow diagram illustrating one example of the operation of a mobile device in the architecture of FIG. 1, in generating a drawing for integration into an e-mail message.

FIGS. 4A-4E are examples of user interface displays.

FIG. 5 is a block diagram showing one example of the architecture illustrated in FIG. 1, deployed in a cloud computing architecture.

FIGS. 6-8 show examples of mobile devices that can be used in the architectures shown in the previous figures.

FIG. 9 is a block diagram of a computing environment that can be used in the architectures shown in the previous figures.

### DETAILED DESCRIPTION

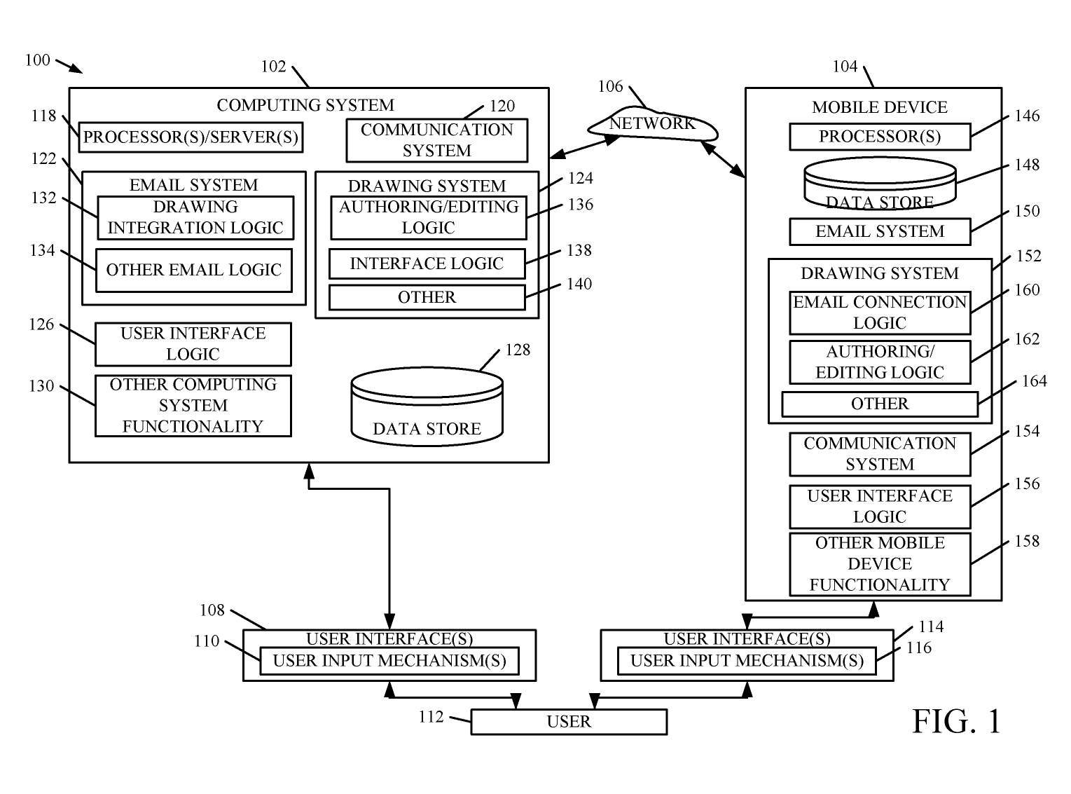

FIG. 1 is a block diagram of one example of a computing system architecture 100. Architecture 100 illustratively includes computing system 102 and mobile device 104 connected through network 106. Network 106 can be any of a wide variety of different types of networks, such as a wide area network, a local area network, a cellular network, a near field communication network, among others.

FIG. 1 also shows that, in one example, computing system 102 generates user interfaces 108 with user input mechanisms 110, for interaction by user 112. Mobile device 104 also illustratively generates user interfaces 114, with user input mechanisms 116, for interaction by user 112. User 112 illustratively interacts with the user input mechanisms 110 in order to control and manipulate computing system 102. User 112 illustratively interacts with user input mechanisms 116 in order to control and manipulate mobile device 104.

Before describing the operation of architecture 100 in more detail, an overview of some of the items in architecture 100, and their operation, will first be provided. Computing system 102 illustratively includes processors or servers 118, communication system 120, e-mail system 122, drawing system 124, user interface logic 126, data store 128, and it can include a wide variety of other computing system functionality or components 130. E-mail system 122, itself, illustratively includes drawing integration logic 132, and it can include a wide variety of other e-mail logic 134. Drawing system 124, itself, illustratively includes authoring/editing logic 136, interface logic 138, and it can include other items 140. Communication system 120 can be used by computing system 102 to communicate over network 106. It can be a variety of different communication systems, and may depend on the type of network it is interacting with.

E-mail system 122 can be an e-mail service or a client component of an e-mail service, or a combination. It illustratively generates user interface displays with user input mechanisms that allow user 112 to perform electronic mail operations, such as compose messages, send and receive messages, reply to messages, attach items, arrange mailbox folders, etc.

Drawing integration logic 132 illustratively allows the user to integrate a drawing into an electronic mail message. As is discussed in greater detail below, the drawing can be generated on computing system 102, using drawing system 124, or it can be generated on an external device, such as mobile device 104, on which a user may feel more comfortable drawing. Authoring/editing logic 136 in drawing system 124 illustratively exposes user interfaces with user input mechanisms that allow user 112 to provide drawing inputs using those mechanisms. The drawing inputs illustratively generate a drawing on a display device of computing system 102 and also generate a corresponding drawing file representing that drawing.

Interface logic 138 illustratively interfaces with drawing integration logic 132 in e-mail system 122, so that the drawing can be generated from within e-mail system 122 and so that the drawing can be integrated into an e-mail message in system 122, in-line with other message content. For instance, when a user wishes to use drawing system 124 to generate a drawing that is to be integrated into an e-mail message, drawing integration logic 132 may open a window in an e-mail user interface and launch drawing system 124 in that window, allowing the user to generate a drawing in the window, on the e-mail user interface. When the user actuates a suitable user input mechanism, drawing integration logic 132 may integrate the drawing into the message body of the e-mail message, in-line with other message content. It may also save the drawing file for later reference.

User interface logic 126 can illustratively generate user interface displays and detect user inputs from the various user input mechanisms 110 and notify other components of computing system 102 of those detected inputs. Data store 128 illustratively stores applications and a wide variety of other items that can be used by computing system 102.

In the example shown in FIG. 1, mobile device 104 also illustratively includes one or more processors 146, data store 148, e-mail system 150, drawing component 152, communication system 154, user interface logic 156, and it can include a wide variety of other mobile device functionality 158. As with e-mail system 122, e-mail system 150 may be a client component of a hosted e-mail service, or another type of e-mail system. Drawing component 152, itself, illustratively includes e-mail connection logic 160, authoring/editing logic 162, and it can include other items 164. E-mail connection logic 160 illustratively connects with e-mail system 122 on computing system 102 so that any drawings generated using drawing component 154 on mobile device 104 can be integrated into an e-mail message being authored on computing system 102. Authoring/editing logic 162, like logic 136 in computing system 102, illustratively exposes user input mechanisms that can be actuated by user 112 in order to generate a drawing.

Communication system 154 can be any of a wide variety of different communication systems that allow mobile device 104 to communicate with computing system 102. It can do so over network 106 or over another network.

User interface logic 156 illustratively generates user interfaces 114 and detects user inputs through user input mechanisms 116. It can notify other items on mobile device 104 about those inputs so that user 112 can control and manipulate mobile device 104.

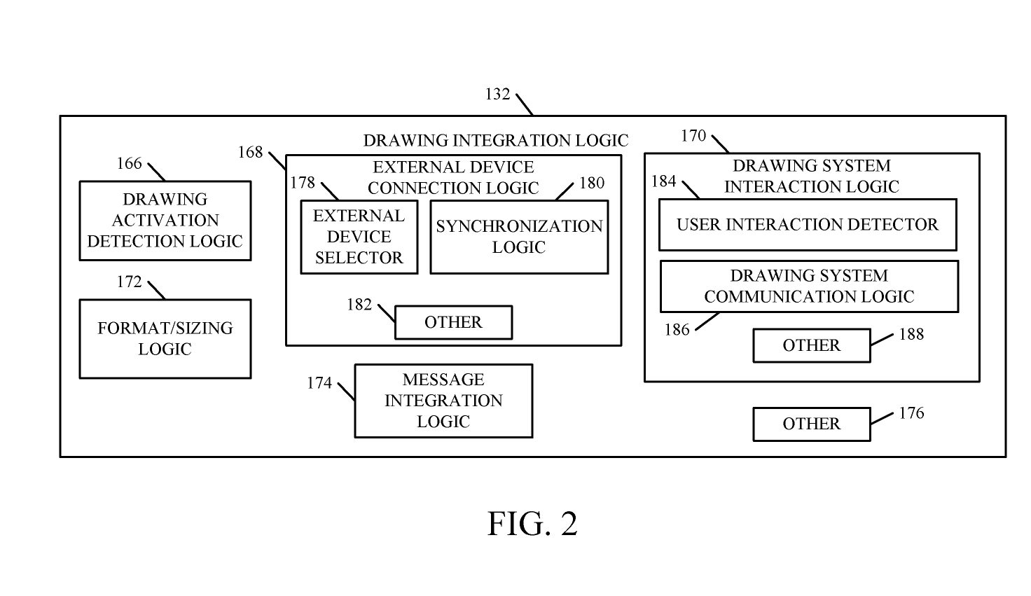

FIG. 2 is a block diagram showing one example of drawing integration logic 132 in more detail. Logic 132 illustratively includes drawing activation detection logic 166, external device connection logic 168, drawing system interaction logic 170, format/sizing logic 172, message integration logic 174, and it can include a wide variety of other items 176.

Drawing activation detection logic 166 detects when the functionality of drawing integration logic 132 is activated. This can be done by the user actuating a user input mechanism, or in other ways, some of which are described below. External device connection logic 168 includes external device selector 178 that generates a user input mechanism that allows the user to select an external device for generating a drawing. It can also include synchronization logic 180 that synchronizes with the external device (such as by providing the external device with the login session ID or other identifier that can be used for synchronizing or uploading a drawing into an e-mail message). It can include other items 182 as well.

Drawing system interaction logic 170 illustratively includes user interaction detector 184, drawing system communication logic 186, and it can include other items 188. Drawing system interaction logic 170 can be used when the user elects to generate the drawing using the local drawing system 124, instead of an external device. It can open a pane on an e-mail display and launch drawing system 124 in that pane so the user can use the native functionality of the drawing system within that pane. In another example, drawing system interaction logic 170 can, itself, detect user interactions using user interaction detector 184 and communicate those user interactions to authoring/editing logic 136 in drawing system 124. Drawing system 124 can then generate the drawing file based on the user interactions and provide a representation of the drawing file back to drawing system interaction logic 170 through drawing system communication logic 186 so that it can be rendered on the e-mail display. Whether the drawing system 124 is directly interacted with and renders the drawing in a pane within the e-mail display or whether it goes through drawing system interaction logic 170, the user illustratively sees the drawing on the e-mail user interface display, while it is being created.

Format/sizing logic 172 illustratively formats and sizes a drawing that is to be integrated into an e-mail message, based upon the form factor of the device being used, based upon the display device being used, based upon the layout of the e-mail user interface, and/or based upon a wide variety of other criteria. Message integration logic 174 then integrates the drawing into the e-mail message, in-line with other content in the e-mail message. In doing so, it can integrate the logic in a wide variety of different ways. It can integrate it as a preview that can be actuated by a viewer of the e-mail message. When the user actuates the preview, then the functionality of the drawing system can be activated so that the viewer can now interact with the drawing to modify it or interact in other ways.

Message integration logic 174 can also integrate the drawing in a wide variety of different forms. For instance, it can be integrated as a vector drawing with editing capabilities provided in e-mail system 122. It can be integrated as an image with different layers that can be manipulated, such as modified, annotated, etc. The drawing can also be of different content types or media types aside from a line drawing. The particular form of the content that is integrated into the e-mail message will vary based upon the device the user is using to create it or modify it, and based upon the particular drawing system the user is using. Also, the drawing can be modified by opening an image editor that is natively supported within e-mail system 122 or that is external to e-mail system 122. For instance, the drawing can be opened in an image editor that is accessible over network 106, or otherwise.

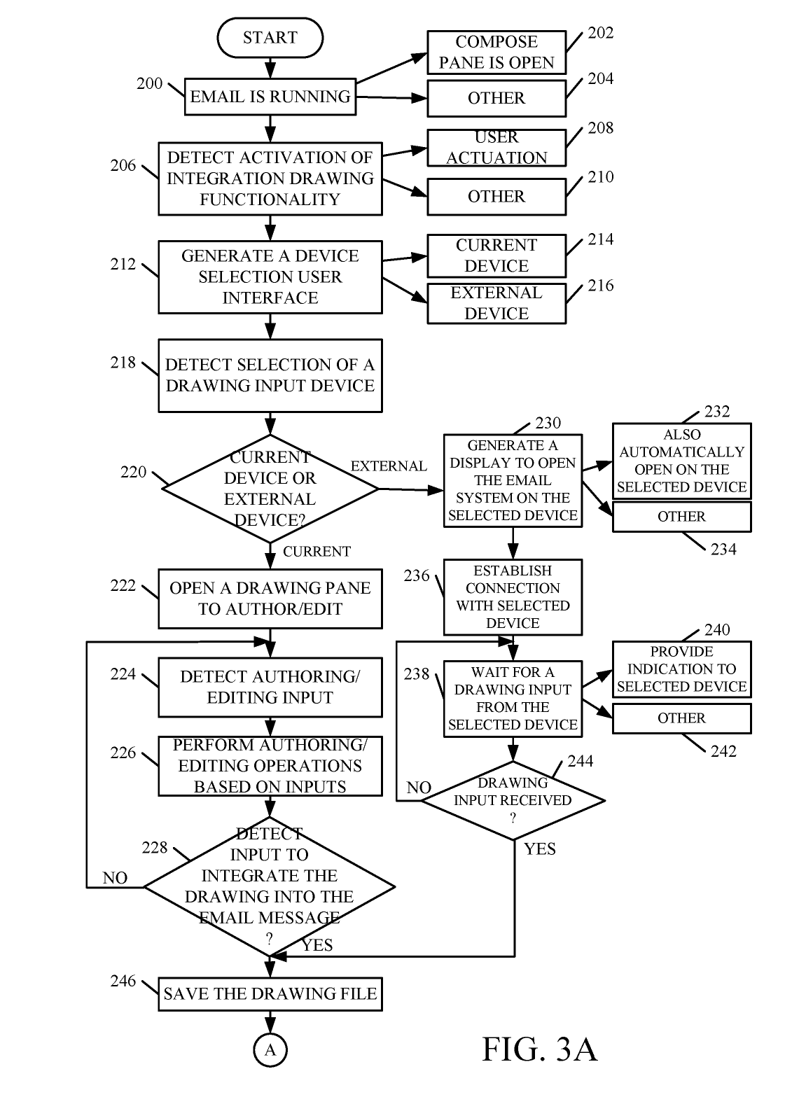

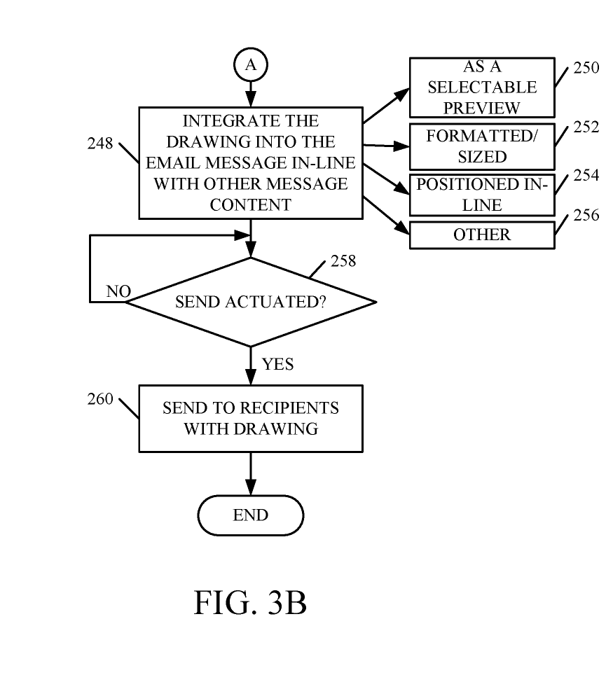

FIGS. 3A and 3B (collectively referred to herein as FIG. 3) illustrate a flow diagram showing the operation of architecture 100 (and drawing integration logic 132) in allowing user 112 to generate and integrate a drawing into an electronic mail message in e-mail system 122, in scenarios in which the user uses drawing system 124 that is local to computing system 102, and when user 112 uses drawing system 152 on an external device (such as on mobile device 104).

It is first assumed that e-mail system 122 is running on computing system 102. This is indicated by block 200 in the flow diagram of FIG. 3. In one example, e-mail system 122 has a compose pane open so that user 112 can compose an electronic mail message with message content. Having a compose pane open in the e-mail system is indicated by block 202. The e-mail system can be running in other ways as well, and this is indicated by block 204.

At some point, drawing activation detection logic 166 (shown in FIG. 2) detects activation of the drawing integration functionality, indicating that user 112 wishes to integrate a drawing into the message body. This is indicated by block 206 in FIG. 3. In one example, user 112 can actuate a user input mechanism to activate the drawing integration functionality. This is indicated by block 208. The drawing integration functionality can be activated in other ways, such as automatically based upon the linguistic content of the e-mail message, based upon the context of computing system 102 (such as which applications are open, etc.) or in a wide variety of other ways. This is indicated by block 210 in FIG. 3.

In response, external device selector 178 illustratively generates a device selection user interface that allows the user to indicate that he or she is going to generate the drawing using drawing system 124 on computing system 102, or using a selected external device. Generating the device selection user interface is indicated by block 212. Generating the display with user input mechanisms allowing the user to select the current device (or current computing system) 102 is indicated by block 214. Generating user input mechanisms that allow the user to select an external device is indicated by block 216 in FIG. 3.

External device selector 178 detects a user actuation of the input mechanism to select a drawing input device that the user will use in order to generate the drawing that will subsequently be integrated into the e-mail message. Detecting selection of the input device is indicated by block 218 in FIG. 3.

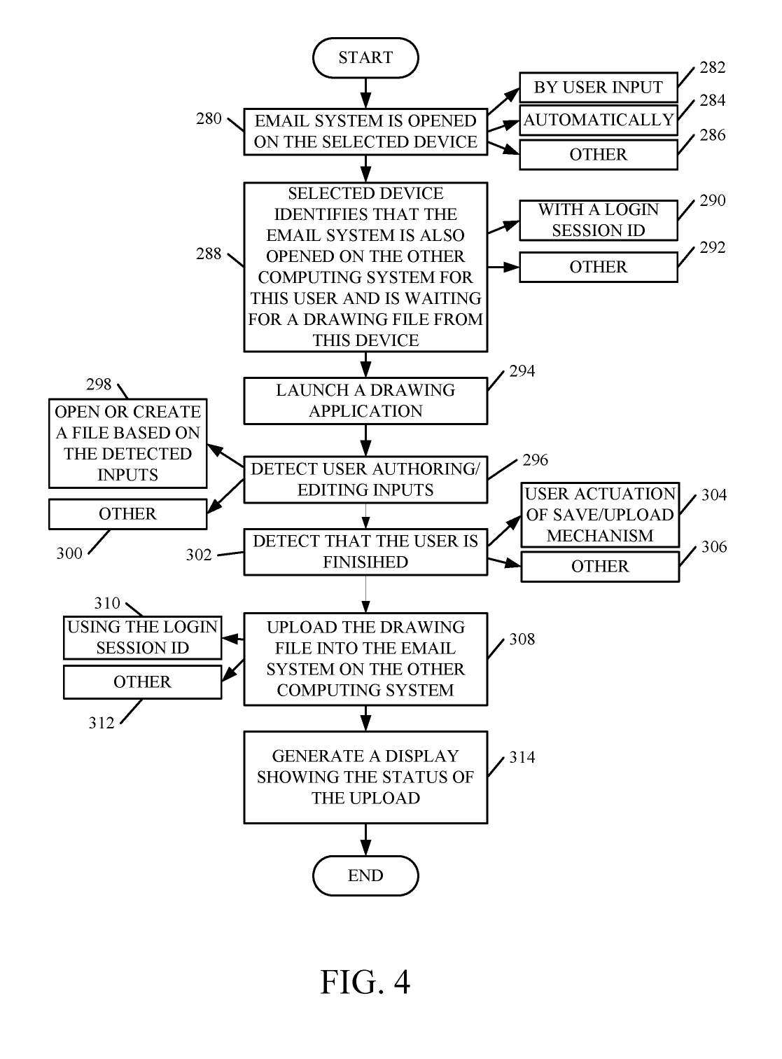

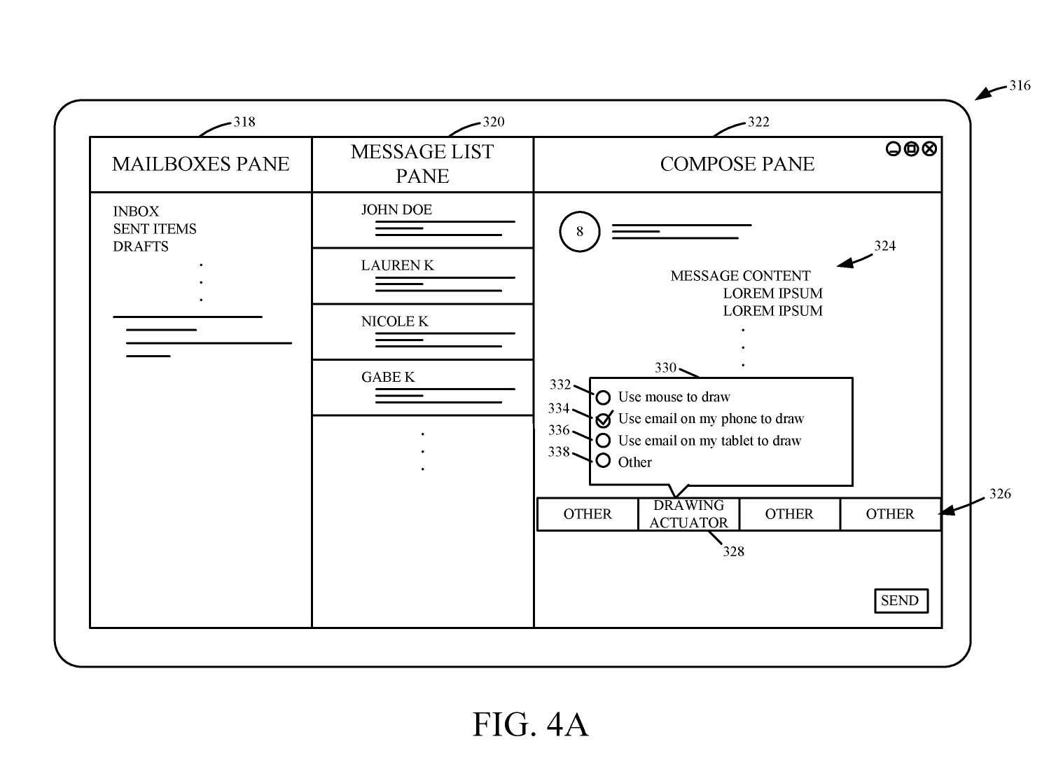

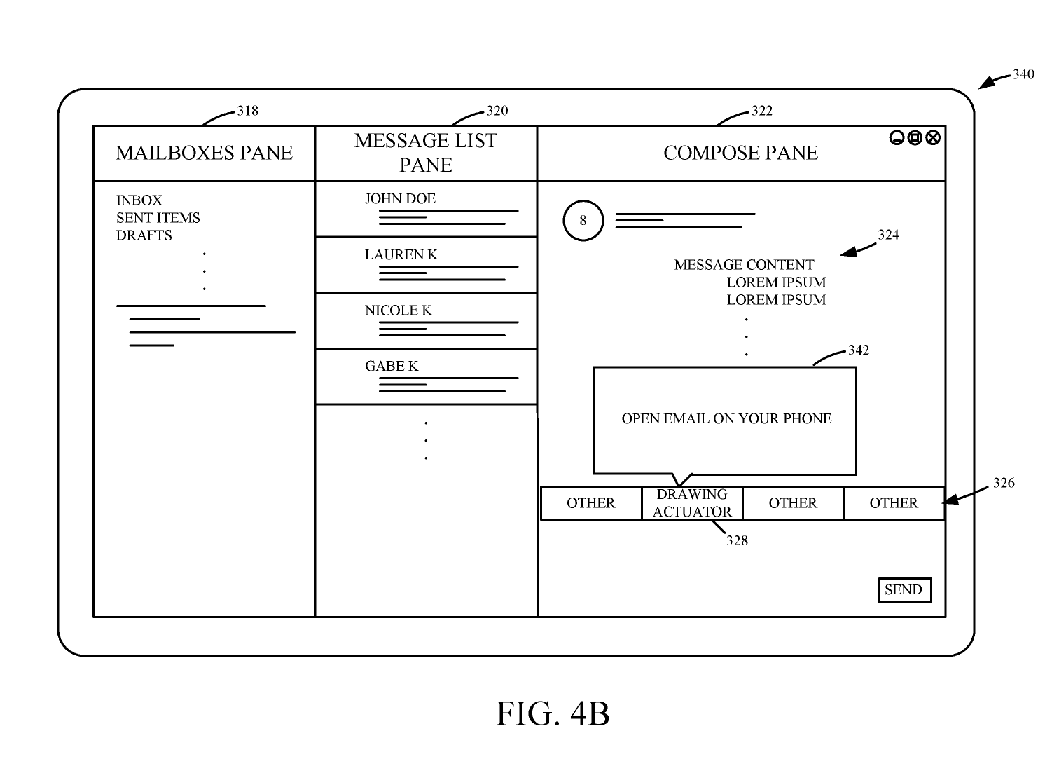

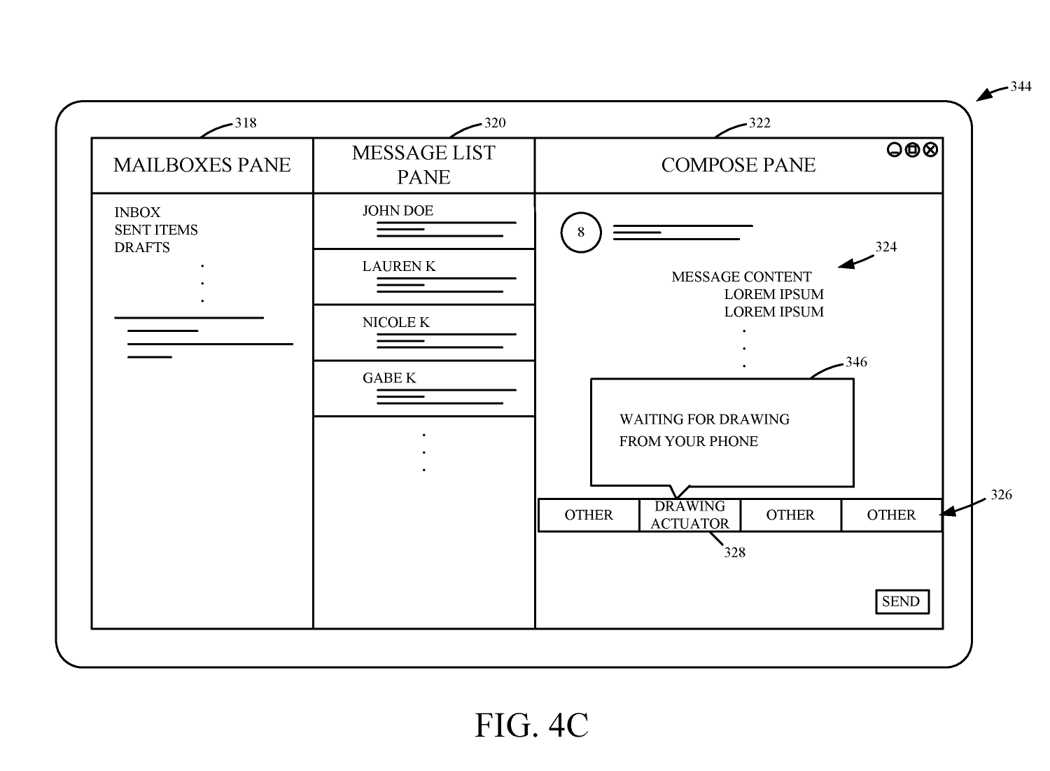

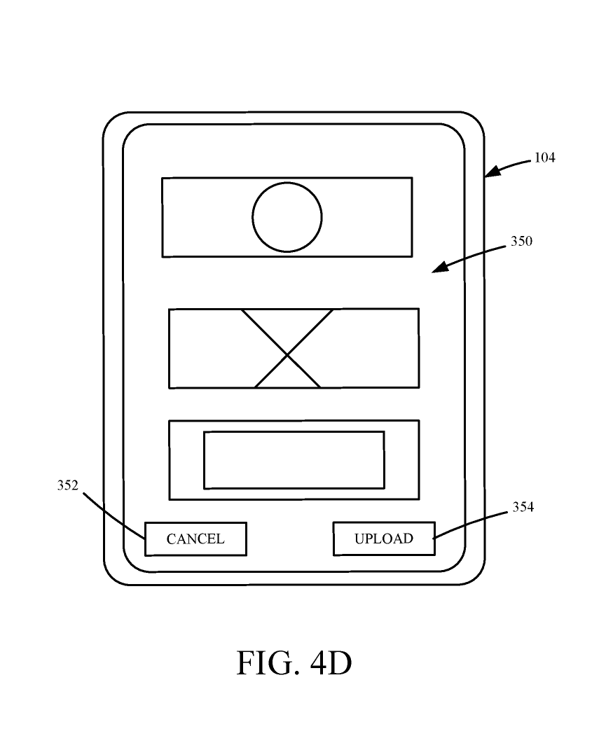

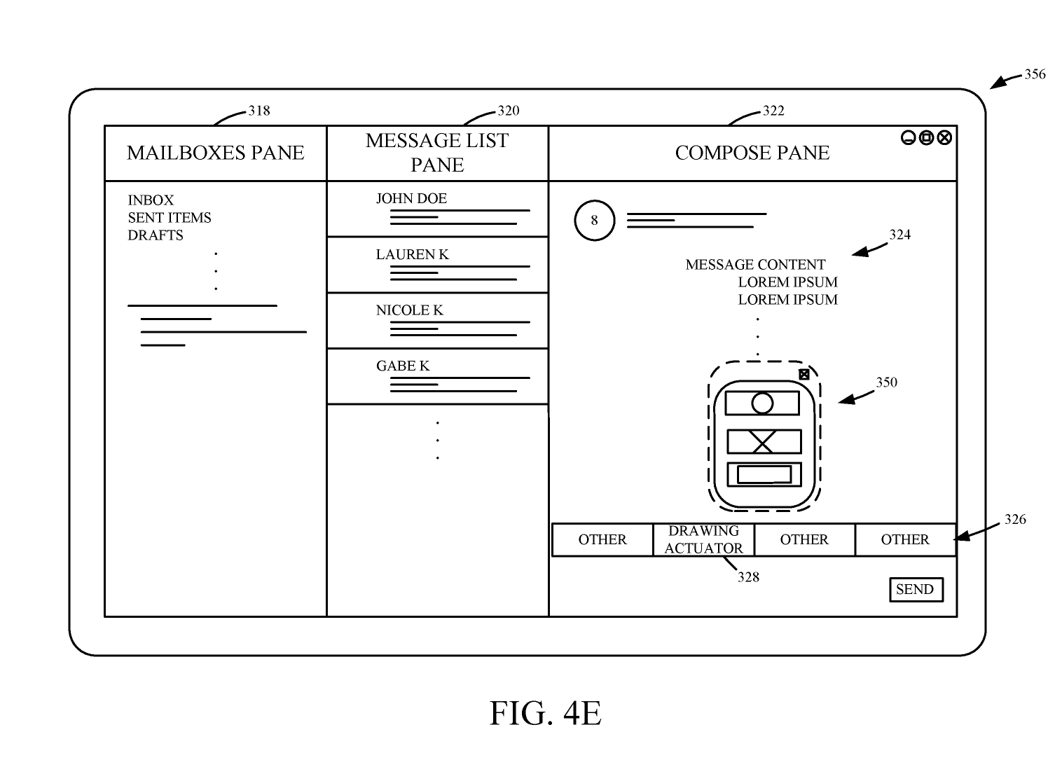

In one example, external device selector 178 generates a user input mechanism that allows the user to select either the current device that the user is working on (e.g., computing system 102) or an external device that may be easier to draw on. Examples of this are described below with respect to FIGS. 4A-4E. Determining whether the user has selected the current device or an external device for generating the drawing is indicated by block 220 in the flow diagram of FIG. 3.

If the user selects the current device, then drawing system interaction logic 170 can operate in a number of different ways, in order to allow the user to generate a drawing on the current device and to integrate that drawing into the e-mail message. In one example, it opens a drawing pane on the e-mail display, with user input mechanisms provided by authoring/editing logic 136 of drawing system 124. This can be done by launching drawing system 124 into the drawing pane, or by hosting rendering of that pane and the drawing functionality within e-mail system 122, itself. Opening the drawing pane allowing the user to author or edit a drawing is indicated by block 222.

The communications between drawing integration logic 132 and drawing system 124 can be performed by drawing system communication logic 186. In one example, drawing system 124 exposes an interface that can be called to perform operations using drawing system 124. Drawing system communication logic 186 can be used to call or invoke that interface in different ways based on the detected user interactions. This is just one example.

User interaction detector 184 then detects the user interaction with the user input mechanisms to author or edit the drawing. Detecting such inputs is indicated by block 224 in FIG. 3. The authoring or editing operations are then performed on the drawing based on the detected user inputs. For instance, where the drawing system is hosted by e-mail system 122, then user interaction detector 184 detects user interactions in the hosted drawing system. However, where the drawing system is external to e-mail system 122 (such as where drawing system 124 is used), then user interaction detector 184 can detect the user interactions and provide them to drawing system 124 which, itself, performs the authoring or editing operations based on the user inputs. Performing authoring and editing operations on the drawing based on the detected user inputs is indicated by block 226 in FIG. 3.

When user 112 has finished generating the drawings, or otherwise wishes to integrate it into the e-mail message, the user illustratively provides a user input indicating that. Message integration logic 174 detects that input and uses format/sizing logic 172 to format and size the drawing so that it can be integrated into the message pane of the e-mail message generated by user 112, in-line with other message content. Detecting the input to integrate the drawing into the e-mail message is indicated by block 228.

Referring again to block 220 in FIG. 3, assume now that the user has selected an external device on which to generate the drawing. In one example, synchronization logic 180 in external device connection logic 168 generates a display on the device that the user is currently using that instructs the user to open the e-mail system on the selected device. This is indicated by block 230 in the flow diagram of FIG. 3. In one example, it can also automatically open the e-mail system on the selected device as indicated by block 232. It can perform other operations in order to have the e-mail system opened on the selected device as well, and this is indicated by block 234.

Synchronization logic 180 then establishes a connection with the selected device. This is indicated by block 236. In one example, it sends an appropriate message or a notification to e-mail connection logic 160 in drawing system 152 on the selected device. The message or notification may include the login session ID that the user is currently working in, in e-mail system 122 on computing system 102. Establishing the connection can be done in other ways as well.

Synchronization logic 180 then holds e-mail system 122 in a state in which it is waiting for a drawing to be input by the external device. This is indicated by block 238 in FIG. 3. In one example, this is done synchronously with the other operations of email system 122 so the user generates and integrates the drawing before performing other operations. It will be noted that, in another example, integration of the drawing can be asynchronous with the other operations of e-mail system 122. Therefore, the user may be able to perform other actions in e-mail system 122 before completing and integrating the drawing. For instance, the user may be able to view other e-mail messages, input additional message content, or perform other operations in e-mail system 122. In one example, even while this is happening, synchronization logic 180 is still waiting for a drawing to be input from the external device.

In one example, synchronization logic 180 can also provide an indication that it is waiting for a drawing to the selected device. This is indicated by block 240. It can wait for the drawing to be input in other ways as well, and this is indicated by block 242.

As is described in greater detail below with respect to FIG. 4, the user can then use the selected device (e.g., mobile device 104) to generate a drawing file representative of a drawing that the user creates on that device, and upload it to computing system 102. Detecting that the drawing has been input by the selected device is indicated by block 244 in the flow diagram of FIG. 3.

Once the drawing file has been received (whether it is received by local drawing system 104 or by a drawing system on an external device such as mobile device 104), message integration logic 174 in e-mail system 122 saves the drawing file so that it can be accessed later (such as if the user wishes to modify it at a later time, etc.). In one example, it can be saved locally to data store 128, but it can be saved remotely as well. Saving the drawing file is indicated by block 246 in the flow diagram of FIG. 3.

Message integration logic 174 then integrates the drawing into the e-mail message, in-line with other message content. This is indicated by block 248. In one example, the drawing is integrated as a selectable preview so that it can be selected and modified by a recipient or by the user at a later time. In one example, when it is selected, it becomes active, with authoring and editing user input mechanisms exposed so that the user can perform editing or authoring operations on the drawing. Integrating the drawing as a selectable preview is indicated by block 250 in the flow diagram of FIG. 3.

Format/sizing logic 172 illustratively performs formatting and sizing of the integrated drawing so that it fits within the e-mail message being generated, in-line with the other content. This is indicated by block 252. Logic 172 also illustratively identifies where, in the message content, the image is to be integrated. This can be done by the user placing his or her cursor at a certain location in the message, or it can be automatically integrated at the bottom or top of the message or at another predefined location. Positioning the drawing in-line with the other message content is indicated by block 254. Integration of the drawing can involve other steps (such as converting the form of the drawing file, etc.) or it can be done in other ways as well, and this is indicated by block 256.

At some point, it may be that user 112 wishes to send the e-mail, with the integrated drawing, to the recipients of the e-mail message. The user may thus actuate a send actuator to send the e-mail to the recipients. Detecting actuation of the send actuator and sending the e-mail message, with the drawing integrated in-line with the other message content, to the recipients, is indicated by blocks 258 and 260 in the flow diagram of FIG. 3.

FIG. 4 is a flow diagram illustrating one example of the operation of an external, selected device, that the user has selected, and on which the user will generate the drawing. In the example discussed with respect to FIG. 4, the selected, external device is mobile device 104.

It is first assumed that the e-mail system 150 is opened on the mobile device 104. This is indicated by block 280 in FIG. 4. As discussed above, the email system 150 can be manually opened by user 112 providing a user input. This is indicated by block 282. It can also be opened automatically by receiving a command, message or notification from synchronization logic 180 on computing system 102. This is indicated by block 284. It can be opened in other ways as well, and this is indicated by block 286.

Mobile device 104 then identifies that the e-mail system 122 is also opened on the other computing system 102 for the present user 112, and that it is waiting for a drawing file from mobile device 104. This is indicated by block 288 in FIG. 4. For instance, and as briefly mentioned above, this can be indicated by synchronization logic 180 sharing the login session ID of the e-mail session that user 112 is currently in, in e-mail system 122. The login session ID can be shared with e-mail connection logic 160 in mobile device 104 so that mobile device 104 can obtain the information indicating that the synchronization logic 180 is waiting for a drawing from mobile device 104. Synchronizing with mobile device 104 using the login session ID is indicated by block 290. This can be done in other ways as well, and this is indicated by block 292.

E-mail system 150 can then automatically launch a drawing application (or drawing system) 152 on mobile device 104 or in a location accessible by mobile device 104. In another example, the user launches the drawing system 152 by using a suitable user input mechanism. Launching the drawing application or drawing system 152 on mobile device 104 is indicated by block 294 in FIG. 3.

The authoring/editing logic 162 of drawing system 152 then exposes user input mechanisms that allow the user to author or edit a drawing. Logic 162 detects the user inputs and, in response, it can open or create a file based on the detected inputs, and begin generating the drawing file based on the detected inputs. Detecting the user authoring/editing inputs is indicated by block 296 and opening or creating a file based on those detected inputs is indicated by block 298. The inputs can be detected in other ways, and other operations can be performed in response to that detection as well, and this is indicated by block 300.

At some point, drawing system 152 will detect that the user has finished generating the drawing file. This is indicated by block 302. This can be done based on user actuation of a “save” or “upload” user input mechanism, or another user input mechanism. This is indicated by block 304. Detecting that the user is finished with the drawing file can be done in other ways as well, and this is indicated by block 306.

In response to detecting that the user has finished authoring or editing the drawing file, e-mail connection logic 160 uploads the drawing file (e.g., through e-mail system 150) into the session on e-mail system 122 that the user 112 is currently in. Uploading the drawing file is indicated by block 308 in FIG. 4. Again, this can be done using the session ID so that the drawing is uploaded into the current session in e-mail system 122. This is indicated by block 310. It can be uploaded in other ways as well, and this is indicated by block 312.

User interface logic 156 on mobile device 104 then generates a display showing the status of the upload (e.g., that the upload is in progress, that it has been completed, etc.). This is indicated by block 314 in FIG. 4.

FIGS. 4A-4E show a number of different examples of user interface displays that can be generated by the various devices in architecture 100. FIG. 4A is one example of a user interface display 316 in e-mail system 122 that allows user 112 to compose an e-mail message. Display 316 illustratively includes a mailboxes pane 318, a message list pane 320, and a compose pane 322. Mailboxes pane 318 illustratively lists the various mailboxes that the user has configured on the e-mail system, such as an inbox, a sent items box, a drafts box, etc. Message list pane 320 illustratively includes identifying information identifying messages that have been received by the user, in the user's inbox. Compose pane 322 illustratively allows the user to input message content 324 in composing a message.

In one example, compose pane 322 includes a set of actuators 326 that can, include a drawing actuator 328. If the user actuates drawing actuator 328, this activates the functionality of drawing integration logic 132, as discussed above. In another example, and as also discussed above, that functionality can be activated automatically based on the content of the message being authored or in other ways. For instance, the message content can be subjected to natural language understanding or natural language processing to obtain an indication of the semantic content or linguistic content of the message. If that content indicates that the drawing integration logic should be activated, then that can automatically be detected.

In one example, when the drawing integration logic is activated (such as when the user actuates drawing actuator 328), external device selector 178 (shown in FIG. 2) generates a user interface mechanism that allows the user to select a device on which the drawing will be generated. In the example shown in FIG. 4A, actuation of actuator 328 causes external device selector 178 to generate a popup display 330 that includes a plurality of different user actuatable elements 332, 334, 336 and 338. When the user actuates display element 332, the user has selected to use the mouse on computing system 102 to generate the drawing. When the user actuates display element 334, the user has selected to use the e-mail system on the user's phone to generate the drawing. When the user actuates display element 336, the user has selected to use the e-mail system on the user's tablet computer to generate the drawing, and when the user actuates display element 338, other options can be presented.

FIG. 4B shows another user interface display 340 that is similar to display 316 shown in FIG. 4A, and similar items are similarly numbered. However, FIG. 4B is generated when the user has selected to use his or her phone to generate the drawing. In response, synchronization logic 180 illustratively generates popup display 342 instructing the user to open the e-mail system on the user's phone or mobile device 104.

At some point, synchronization logic 180 then generates another display, such as that shown in FIG. 4C. FIG. 4C shows user interface display 344, which is similar to display 340 shown in FIG. 4B, and similar items are similarly numbered. However, it can now be seen that synchronization logic 180 has generated a popup display 346 that indicates that it is waiting for a drawing file from the user's phone.

FIG. 4D shows one example of a user interface display that can be generated on the selected external device (e.g., on the user's phone or mobile device 104). FIG. 4D shows that the user has now generated a drawing 350 using the drawing system 152 on mobile device 104. Drawing system 152 illustratively provides functionality that allows the user to generate such a drawing, and it also creates a drawing file that represents drawing 350. In the example illustrated in FIG. 4D, authoring/editing logic 162 in drawing system 152 also displays a set of actuators that allow the user to cancel the drawing operation or to upload the drawing to e-mail system 122. For instance, FIG. 4D shows that the system has displayed a cancel actuator 352 and an upload actuator 354. When the user has finished generating drawing 350, and wishes to integrate it into the e-mail message being generated within e-mail system 122, the user illustratively actuates the upload actuator 354.

When the user actuates the upload actuator 354, then e-mail connection logic 160 (either by itself or through e-mail system 150 on mobile device 104) uploads the drawing file representing drawing 350 to message integration logic 164, in drawing integration logic 132, for integration into the e-mail message being composed. Format/sizing logic 172 then receives the drawing file and formats the drawing, and sizes it appropriately, so that it can be displayed, in-line with the other message content 324 on the user interface display. FIG. 4E shows a user interface display 356 that indicates this.

FIG. 4E now shows that drawing 350 has been integrated, in-line with the other message content 324 on the e-mail message being displayed. As discussed above, drawing 350 can be integrated as a selectable preview that, when selected by the user (such as by clicking on it) becomes active so that the user can modify drawing 350. This can be done by hosted drawing functionality that is hosted by e-mail system 122, or by opening the drawing in drawing system 124 or in another drawing authoring or editing system. All of these are contemplated herein.

It can thus be seen that the present system greatly enhances the operation of the computing system. In prior systems, a user would need to generate a drawing by separately navigating to drawing system 124, generating the drawing, then attaching it to an electronic mail message. The attachment can often get detached from the electronic mail message (such as when a user replies to the message or in other ways). However, by automatically integrating the drawing into the message body, in-line with other message content, the drawing will follow the message, whether it is forwarded, responded to by a recipient, etc. This not only ensures that the drawing does not get separated from the electronic mail message, and thus keeps the drawing within the context of the email conversation that spawned it, but it also saves processing and memory overhead in rendering user interface displays. Instead of navigating the user to a completely separate user interface display that is used for drawing, it can open a drawing pane within in the e-mail user interface display.

Similarly, it can automatically synchronize with an external device, when the user selects an external device to perform the drawing operation. Because some devices are easier to draw on, and some are easier to type or create linguistic content on, the user may wish to use two devices to author an e-mail message. The present system automatically allows the user to select an external device for generating a drawing and then automatically integrates that drawing into the body of the e-mail message, in-line with other message content. This is advantageous in that the user need not create the drawing on the external device, then somehow send it to the first device and save it, then somehow open it on the first device and attach it to the email. The present system saves time, computing and memory overhead as well as interactions with a hosted email system. Thus, it also reduces network traffic.

The present discussion has used the term “automatically”. By “automatically”, it is meant that the operation being referred to is performed without further user involvement, except perhaps to initiate or authorize the operation. This is one example.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

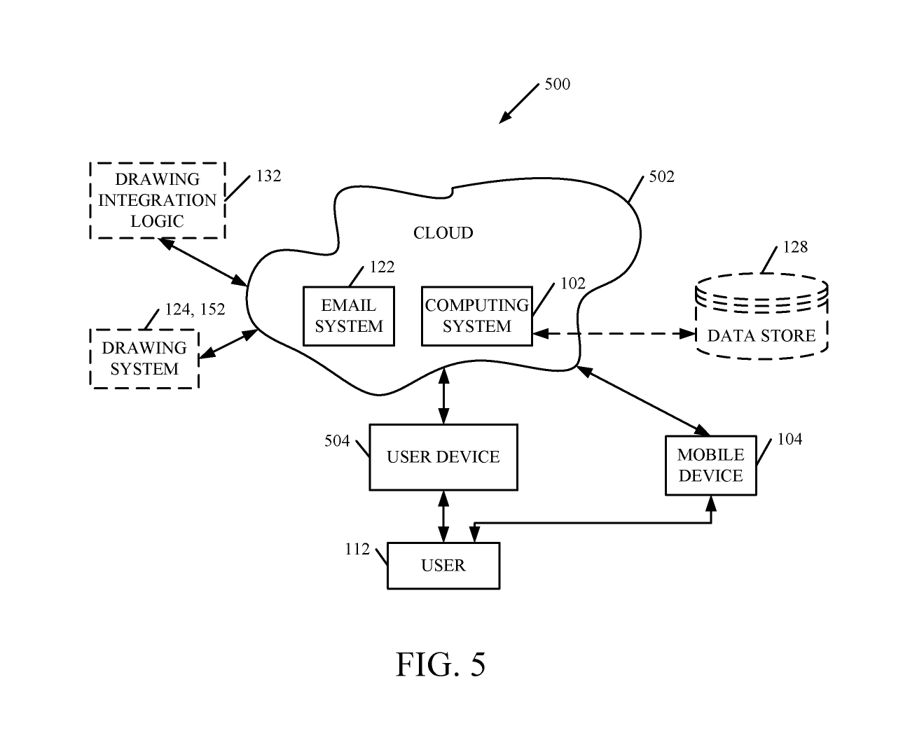

FIG. 5 is a block diagram of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the example shown in FIG. 5, some items are similar to those shown in FIG. 1 and they are similarly numbered. FIG. 5 specifically shows that computing system 102 and email system 122 can be located in cloud 502 (which can be public, private, or a combination where portions are public while others are private). Therefore, user 112 uses a user device 504 and mobile device 104 to access those systems through cloud 502.

FIG. 5 also depicts another example of a cloud architecture. FIG. 5 shows that it is also contemplated that some elements of architecture 100 can be disposed in cloud 502 while others are not. By way of example, data store 128 can be disposed outside of cloud 502, and accessed through cloud 502. In another example, drawing integration logic 132 and/or drawing systems 124 and 152 can also be outside of cloud 502. Regardless of where they are located, they can be accessed directly by devices 504 and 104, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

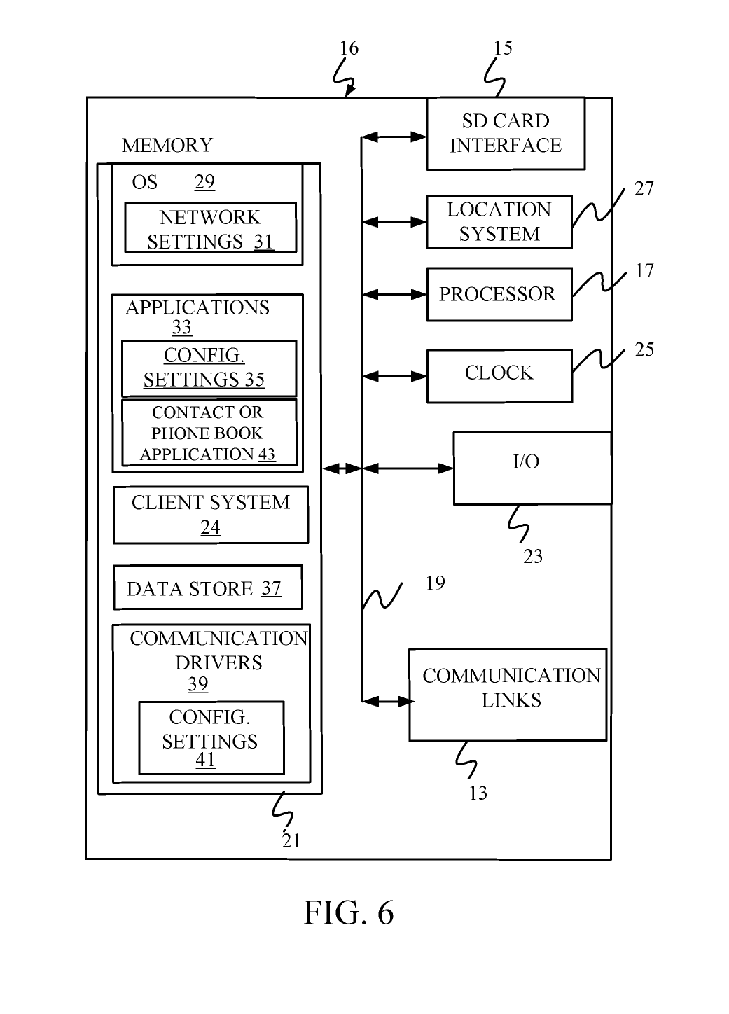

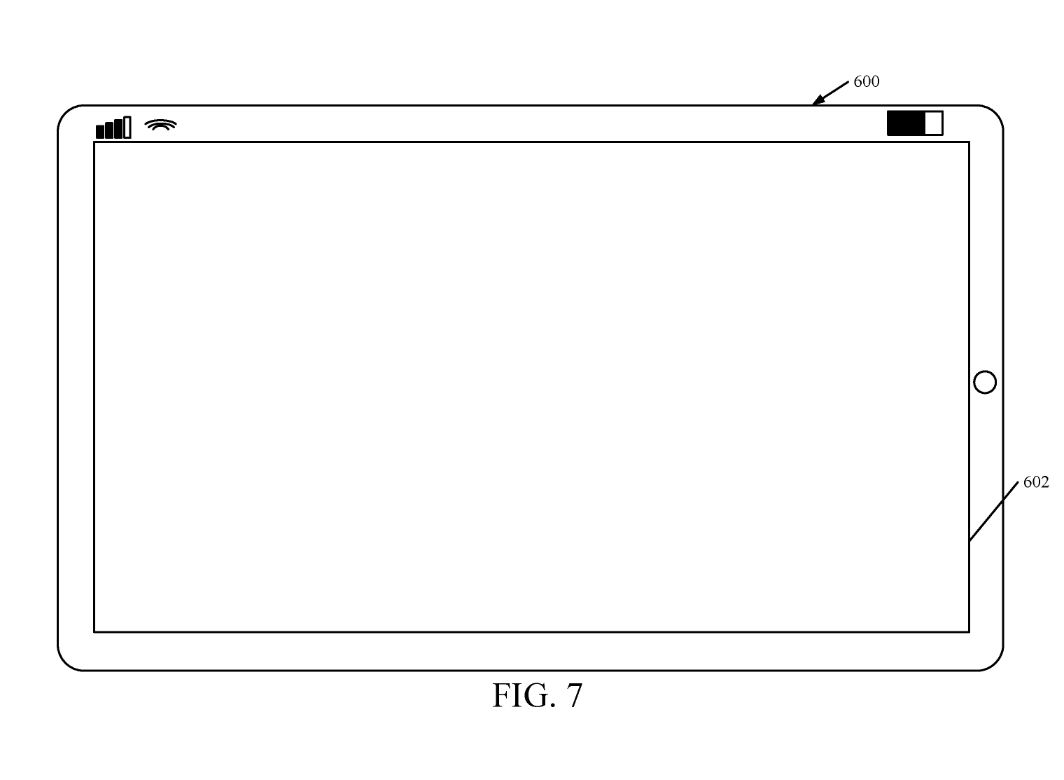

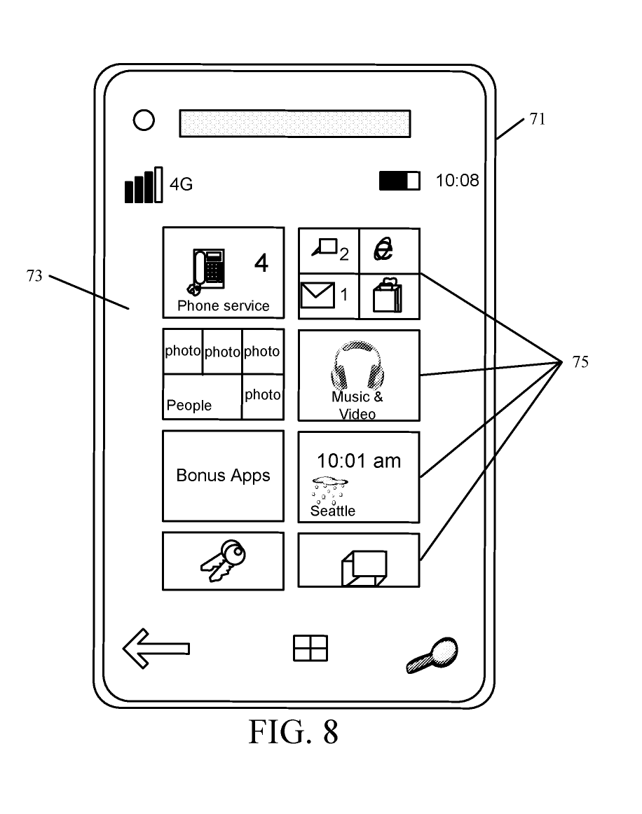

FIG. 6 is a simplified block diagram of one illustrative example of a handheld or mobile computing device that can be used as a user's or client's hand held device 16, and that can serve as mobile device 104 or in which the present system (or parts of it) can be deployed. FIGS. 7-8 are examples of handheld or mobile devices.

FIG. 6 provides a general block diagram of the components of a client device 16 that can run components of architecture 100 or that interacts with architecture 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as Wi-Fi protocols, and Bluetooth protocol, which provide local wireless connections to networks.

In other examples, applications or systems are received on a removable Secure Digital (SD) card that is connected to a SD card interface 15. SD card interface 15 and communication links 13 communicate with a processor 17 (which can also embody processors or servers from previous Figures) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Similarly, device 16 can have a client system 24 which can run various business applications or embody parts or all of the items on devices 104 and 504. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 7 shows one example in which device 16 is a tablet computer 600. In FIG. 7, computer 600 is shown with user interface display screen 602. Screen 602 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

FIG. 8 shows that the device can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

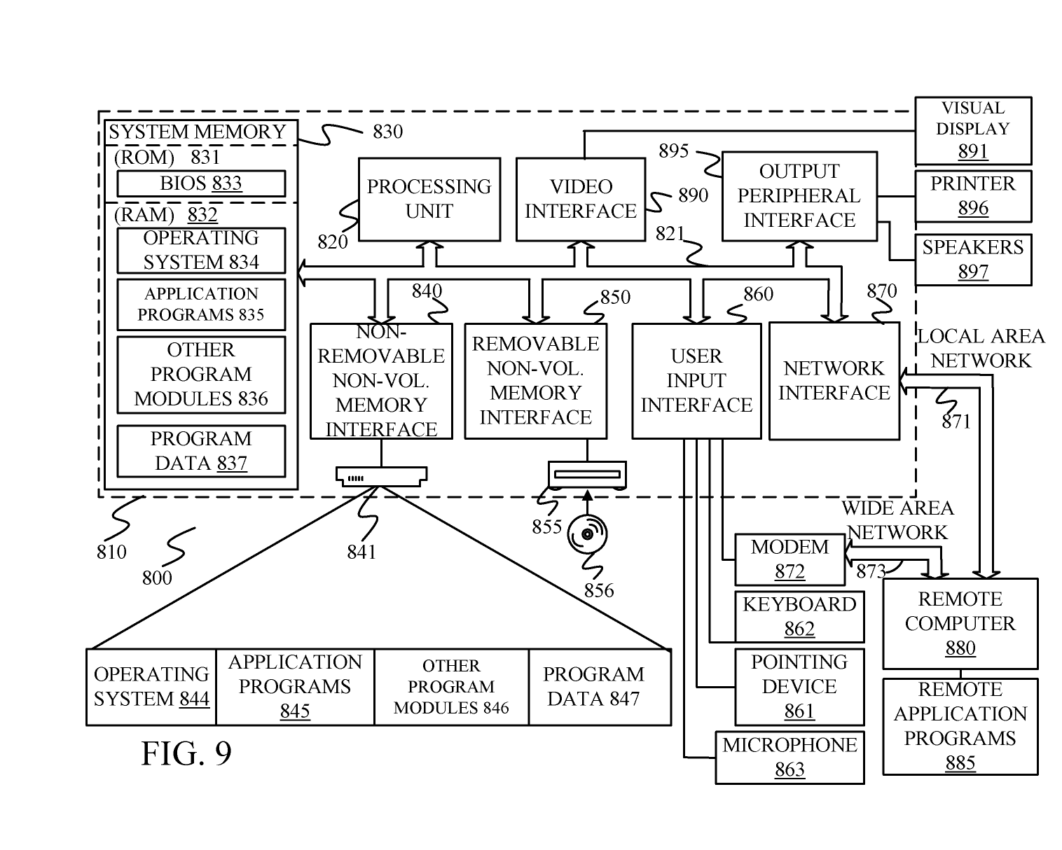

FIG. 9 is one example of a computing environment in which architecture 100, or parts of it, (for example) can be deployed. With reference to FIG. 9, an example system for implementing some embodiments includes a general-purpose computing device in the form of a computer 810. Components of computer 810 may include, but are not limited to, a processing unit 820 (which can comprise servers or processors from previous Figures), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 9.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 9 illustrates operating system 834, application programs 835, other program modules 836, and program data 837.

The computer 810 may also include other removable/non-removable volatile/nonvolatile computer storage media. By way of example only, FIG. 9 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 9, provide storage of computer readable instructions, data structures, program modules and other data for the computer 810. In FIG. 9, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 9 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 9 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Example 1 is a computing system, comprising:

an electronic mail (email) system that generates a user interface display with a compose pane for entering message content in an email message;

drawing integration logic that that communicates with a drawing system and receives a user-generated drawing file from the drawing system; and

message integration logic that integrates an interactive drawing display, based on the drawing file, into the email message on the compose pane, in-line with the message content.

Example 2 is the computing system of any or all previous examples wherein the drawing integration logic comprises:

an external device selector that generates a user input mechanism that is actuated by the user to select an external device on which the user will generate the drawing file.

Example 3 is the computing system of any or all previous examples wherein the drawing integration logic comprises:

synchronization logic that communicates with the external device to receive the drawing file from the external device.

Example 4 is the computing system of any or all previous examples wherein the drawing integration logic comprises:

format/sizing logic that formats and sizes the interactive drawing display for integration into the email message on the compose pane.

Example 5 is the computing system of any or all previous examples wherein the message integration logic integrates the interactive drawing display into the email message as a selectable preview display that is selectable to expose editing mechanisms that are actuated to edit the drawing file through the interactive drawing display.

Example 6 is the computing system of any or all previous examples wherein the drawing integration logic comprises:

drawing activation detection logic that detects an activation input to activate the drawing integration logic.

Example 7 is the computing system of any or all previous examples wherein the synchronization logic generates a user interface display indicating that an email system on the external device is to be launched.

Example 8 is the computing system of any or all previous examples wherein the synchronization logic communicates with the external device to automatically open an email system on the external device.

Example 9 is the computing system of any or all previous examples wherein the drawing integration logic comprises:

drawing system interaction logic that detects user interaction with a drawing user input mechanism and communicates the detected user interaction to the drawing system.

Example 10 is a computer implemented method, comprising:

generating a user interface display, in an electronic mail system, with a compose pane for entering message content in an email message;

receiving a user-generated drawing file from a drawing system; and

integrating an interactive drawing display, based on the drawing file, into the email message on the compose pane, in-line with the message content.

Example 11 is the computer implemented method of any or all previous examples and further comprising:

generating a device selection user input mechanism that is actuated by the user to select an external device on which the user will generate the drawing file; and

detecting actuation of the device selection user input mechanism, identifying the external device.

Example 12 is the computer implemented method of any or all previous examples wherein receiving the user-generated drawing file comprises:

communicating with the external device to receive the drawing file from the external device.

Example 13 is the computer implemented method of any or all previous examples integrating the interactive drawing display comprises:

formatting and sizing the interactive drawing display for integration into the email message on the compose pane.

Example 14 is the computer implemented method of any or all previous examples wherein integrating the interactive drawing display includes integrating the interactive drawing display into the email message as a selectable preview display and further comprising:

detecting selection of the selectable preview display;

in response, exposing an editing mechanism;

detecting user actuation of the editing mechanism; and

editing the drawing file through the interactive drawing display based on the detected user actuation of the editing mechanism.

Example 15 is the computer implemented method of any or all previous examples wherein and further comprising:

detecting an activation input to activate the drawing integration logic.

Example 16 is the computer implemented method of any or all previous examples and further comprising:

after identifying the external device, generating a user interface display indicating that an email system on the external device is to be launched.

Example 17 is the computer implemented method of any or all previous examples wherein communicating with the external device comprises:

after identifying the external device, automatically opening an email system on the external device.

Example 18 is the computer implemented method of any or all previous examples wherein receiving a user generated drawing file comprises:

detecting user interaction with drawing user input mechanisms; and

communicating the detected user interactions to the drawing system.

Example 19 is a computing system, comprising:

an electronic mail (email) system that generates a user interface display with a compose pane for entering message content in an email message;

an external device selector that generates a user input mechanism that is actuated by the user to select an external device on which the user will generate a drawing file;

synchronization logic that communicates with the external device to receive the drawing file from the external device; and

message integration logic that integrates an interactive drawing display, based on the drawing file, into the email message on the compose pane, in-line with the message content.

Example 20 is the computing system of any or all previous examples wherein the drawing integration logic comprises:

format/sizing logic that formats and sizes the interactive drawing display for integration into the email message on the compose pane as a selectable preview display that is selectable to expose editing mechanisms that are actuated to edit the drawing file through the interactive drawing display.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computing system, comprising:
an electronic mail (email) system that generates a user interface display with a compose pane for entering message content in an email message;
drawing integration logic that that communicates with a drawing system and receives a user-generated drawing file from the drawing system; and
message integration logic that integrates an interactive drawing display, based on the drawing file, into the email message on the compose pane, in-line with the message content.

2. The computing system of claim 1 wherein the drawing integration logic comprises:
an external device selector that generates a user input mechanism that is actuated by the user to select an external device on which the user will generate the drawing file.

3. The computing system of claim 2 wherein the drawing integration logic comprises:
synchronization logic that communicates with the external device to receive the drawing file from the external device.

4. The computing system of claim 3 wherein the drawing integration logic comprises:
format/sizing logic that formats and sizes the interactive drawing display for integration into the email message on the compose pane.

5. The computing system of claim 3 wherein the message integration logic integrates the interactive drawing display into the email message as a selectable preview display that is selectable to expose editing mechanisms that are actuated to edit the drawing file through the interactive drawing display.

6. The computing system of claim 3 wherein the drawing integration logic comprises:
drawing activation detection logic that detects an activation input to activate the drawing integration logic.

7. The computing system of claim 3 wherein the synchronization logic generates a user interface display indicating that an email system on the external device is to be launched.

8. The computing system of claim 3 wherein the synchronization logic communicates with the external device to automatically open an email system on the external device.

9. The computing system of claim 1 wherein the drawing integration logic comprises:
drawing system interaction logic that detects user interaction with a drawing user input mechanism and communicates the detected user interaction to the drawing system.

10. A computer implemented method, comprising:
generating a user interface display, in an electronic mail system, with a compose pane for entering message content in an email message;
receiving a user-generated drawing file from a drawing system; and
integrating an interactive drawing display, based on the drawing file, into the email message on the compose pane, in-line with the message content.

11. The computer implemented method of claim 10 and further comprising:
generating a device selection user input mechanism that is actuated by the user to select an external device on which the user will generate the drawing file; and
detecting actuation of the device selection user input mechanism, identifying the external device.

12. The computer implemented method of claim 11 wherein receiving the user-generated drawing file comprises:
communicating with the external device to receive the drawing file from the external device.

13. The computer implemented method of claim 12 integrating the interactive drawing display comprises:
formatting and sizing the interactive drawing display for integration into the email message on the compose pane.

14. The computer implemented method of claim 12 wherein integrating the interactive drawing display includes integrating the interactive drawing display into the email message as a selectable preview display and further comprising:
detecting selection of the selectable preview display;
in response, exposing an editing mechanism;
detecting user actuation of the editing mechanism; and
editing the drawing file through the interactive drawing display based on the detected user actuation of the editing mechanism.

15. The computer implemented method of claim 12 wherein and further comprising:
detecting an activation input to activate the drawing integration logic.

16. The computer implemented method of claim 12 and further comprising:
after identifying the external device, generating a user interface display indicating that an email system on the external device is to be launched.

17. The computer implemented method of claim 12 wherein communicating with the external device comprises:
after identifying the external device, automatically opening an email system on the external device.

18. The computer implemented method of claim 10 wherein receiving a user generated drawing file comprises:
detecting user interaction with drawing user input mechanisms; and
communicating the detected user interactions to the drawing system.

19. A computing system, comprising:
an electronic mail (email) system that generates a user interface display with a compose pane for entering message content in an email message;
an external device selector that generates a user input mechanism that is actuated by the user to select an external device on which the user will generate a drawing file;
synchronization logic that communicates with the external device to receive the drawing file from the external device; and
message integration logic that integrates an interactive drawing display, based on the drawing file, into the email message on the compose pane, in-line with the message content.

20. The computing system of claim 19 wherein the drawing integration logic comprises:
format/sizing logic that formats and sizes the interactive drawing display for integration into the email message on the compose pane as a selectable preview display that is selectable to expose editing mechanisms that are actuated to edit the drawing file through the interactive drawing display.
